(19) United States
(12) Patent Application Publication
(10) Pub. No.: US 2022/0214188 A1
(43) Pub. Date: Jul. 7, 2022

(54) Efficiently Encoding Route Data for Obtaining Route Updates

(71) Applicant: Apple Inc., Cupertino, CA (US)

(72) Inventors: Michael T. Wegner, Berlin (DE); Daniel R. Delling, Sunnny Vale, CA (US)

(73) Assignee: Apple Inc., Cupertino, CA (US)

(21) Appl. No.: 17/451,014

(22) Filed: Oct. 15, 2021

Related U.S. Application Data
(60) Provisional application No. 63/134,091, filed on Jan. 5, 2021.

(51) Int. Cl. G01C 21/00; G01C 21/36; G01C 21/34; G01C 21/30

(52) U.S. Cl. CPC G01C 21/3874; G01C 21/3605; G01C 21/3889; G01C 21/3856; G01C 21/30; G01C 21/343

(57) ABSTRACT

In some implementations, a route between a starting point and a destination point may be encoded in a map-independent way. A route is an ordered list of segments that connect the starting point to the destination point. By being map-independent, the route can be encoded on one map version, such as at a server device, and later decoded on a different map version, such as on a user device. In an embodiment, the user device may decode the route using the same codec library that was used by the server to encode the route. Moreover, in an approach, the user device may select a subset of support points along the route to provide to the server which are sufficient to describe the route in order to conserve resources. Using these techniques, a route can be encoded in a very space efficient way with a decoding error rate close to 0%.

### RELATED APPLICATIONS

This application claims the benefit of the filing date of U.S. Provisional Patent Application No. 63/134,091 filed on Jan. 5, 2021, which is hereby incorporated by reference.

### TECHNICAL FIELD

The disclosure relates generally to navigation systems, and more particularly, to efficiently encoding route data for requesting route information.

### BACKGROUND

Mobile devices, such as smartphones, are commonly used to perform navigation and mapping functions. The mobile devices may include navigation and/or mapping applications that present maps, search for locations, and/or provide navigation and routing instructions. Navigation applications on mobile devices have become a primary resource for users to navigate from one location to another by following routes that are provided by the mobile device overlaid upon a map. To provide the most up-to-date navigation information to the mobile device, the mobile device provides route information based on its own map to a server, which responds with updated navigation information based on the server's map.

### SUMMARY

This specification describes techniques for encoding and decoding a route between a starting point and a destination point in a map-independent way. A route is an ordered list of segments that connect the starting point to the destination point. By being map-independent, the route can be encoded on one map version, such as at a server device, and later decoded on a different map version, such as on a user device. In an embodiment, the user device may decode the route using the same codec library that was used by the server to encode the route. Moreover, in an approach, the user device may select a subset of support points along the route to provide to the server which are sufficient to describe the route in order to conserve resources. Using these techniques, a route can be encoded in a very space efficient way with a decoding error rate close to 0%.

In some implementations, a server receives an update request for a current navigation route being used by a navigation application executing on a user device. The update request may include a set of support points and corresponding segment identifiers for the current navigation route, which are used to generate one or more updated navigation routes in accordance with one or more conditions. Also, the server analyzes the set of support points and corresponding segment identifiers to construct the current navigation route. Based on the current navigation route, the server generates one or more ordered series of routing points using a map. The routing points correspond, respectively, to segments on the map. Moreover, the one or more ordered series of routing points and corresponding segments each describe a route from the start point to the destination point according to the one or more conditions. One or more of these ordered series of routing points may be sent to the user device as route data responsive to determining that they are better suited for guiding the user device to the destination point.

In one or more implementations, a user device sends an update request for a current navigation route being used by a navigation application executing on the user device. The user device provides a description of the current navigation route to a server, and receives route data in response. The route data includes one or more ordered series of routing points, each ordered series of routing points describing a route from the start point to the destination point that satisfies one or more conditions. The user device analyzes the route data against a map of the user device to construct one or more updated navigation routes and displays at least one of the one or more navigation routes.

### DESCRIPTION OF DRAWINGS

FIG. 1 is a block diagram of an example system for providing route data for use with a navigation application on a user device.

FIG. 2 illustrates an example map with example segments.

FIGS. 3A-3E shows a series of example user interfaces for providing a route in a navigation application on a user device.

FIG. 4 illustrates example modifications to a map based on updated road information.

FIG. 5 illustrates example modifications to a map based on updated road information.

FIG. 6 illustrates example modifications to a map based on updated road information.

FIG. 7 is a flow diagram of an example method for generating a navigation route for use with a navigation application on a user device.

FIG. 8 is a flow diagram of an example method for decoding a navigation route for use with a navigation application on a user device.

FIG. 9 is a flow diagram of an example method for updating a navigation route being used by a navigation application on a user device.

FIG. 10 is a flow diagram of an example method for requesting an updated navigation route for use with a navigation application on a user device.

FIG. 11 is a flow diagram of an example method for encoding a route for transmission.

FIG. 12 is a block diagram of an example computing device to implement the features and processes of FIGS. 1-11.

Like reference symbols in the various drawings indicate like elements.

### DETAILED DESCRIPTION

According to an embodiment, a route between a starting point (origin) and a destination point on a map may be encoded and/or decoded using an efficient navigation route codec library. The map may be a graph representing actual roads by vertices (junctions) and segments (streets connecting junctions). Each segment has attributes that represent characteristics of the segment. These attributes may include allowed direction of travel on the segment, the geometry of the segment, and the road type. A junction has one or more incident segments. The number of incident segments is referred to as the degree of the junction. A route may be an ordered list of segments that connect the starting point to the destination point. This route may be configured for use within a navigation application, such as on a mobile device like a smartphone. Using the techniques described, encoding and decoding may be map-independent, meaning that the exact same version of the map is not needed to decode the route as was used to encode the route. By using encoding and decoding that is map-independent, mapping and navigation systems, which update maps over time, may avoid expending additional resources to decode a route when a map has been updated. A route is able to be encoded, with a very space-efficient process, by using the navigation route-codec library, which will be described below. This navigation route-codec library also substantially reduces the decoding error rate.

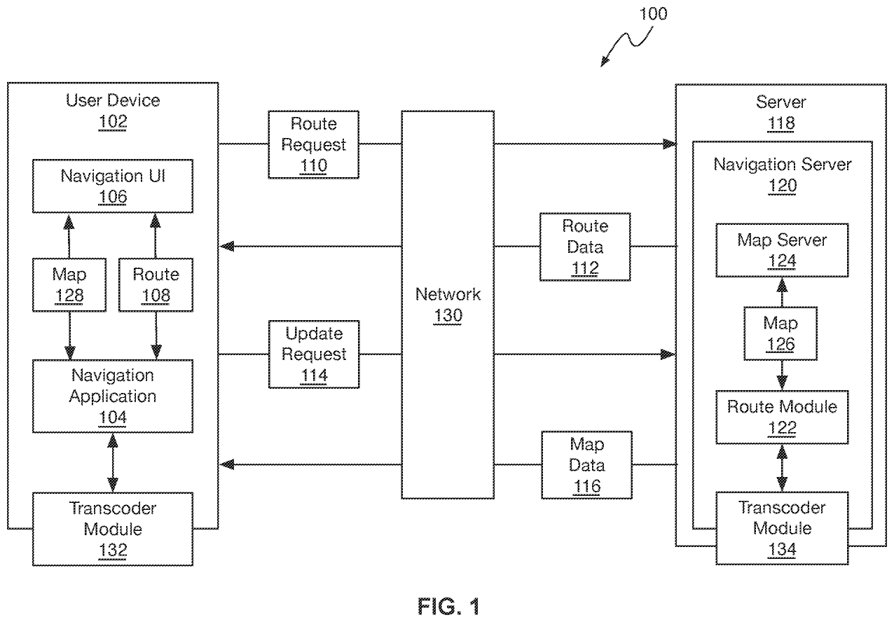

FIG. 1 is a block diagram of an example system 100 for providing a route for use with a navigation application 104 on a user device 102. User device 102 may be any type of computing device having a processor configured to execute navigation application 104 and display a navigation user interface (UI) 106. Some example user devices include, but are not limited to, a smartphone, a tablet computer, a laptop computer, a notebook computer, a wearable computing device, a smartwatch, a fitness tracker with display, an in-car system (navigation, infotainment, etc.), a smart home device, a mobile device having global positioning system (GPS) functionality, etc.

Navigation application 104 may be native to an operating system (OS) of user device 102, an application that is executed by the OS, a plug-in or other add-on functionality for an application on user device 102, etc. Navigation application 104 may be downloaded and/or provided by a third-party to user device 102, come installed and/or equipped with user device 102 when purchased or acquired, or otherwise made accessible to user device 102. Navigation application 104 is configured to display a map 128 and, upon request by a user of user device 102, a navigation route 108 to provide instructions to the user to travel from an origin to a destination while displaying movement of the user device 102 upon map 128 via navigation UI 106. To initiate generation of route 108 by server 118, user device 102 sends route request 110 to server 118. Route request 110 may include a start point, an end point, and attributes for these points (e.g., coordinates for each of these points upon map 128).

Server 118 is a hardware device having one or more processors and at least one storage device. It is configured to communicate with user device 102, directly and/or via one or more networks 130. Server 118 comprises a navigation server 120. Navigation server 120 generates route data 112 and/or map data 116 to be used with navigation application 104 on user device 102. Route data 112 may be generated upon receiving a route request 110 and updated and/or confirmed upon receiving an update request 114 from user device 102.

Route data 112 may describe one or more navigation routes to transverse from a start point to an end point along with attributes for routing points (including the start and end points) along the route. Route data 112 may also include identification of segments corresponding, respectively, to routing or support points along the route. In an embodiment, segment identifiers are used to identify the segments of a route. Additional information may also be conveyed by navigation server 120 to user device 102 in route data 112 to enhance functionality and capabilities of user device 102 when displaying a route.

In an embodiment, route data 112 may be provided by navigation server 120 periodically to ensure route 108 on user device 102 is up-to-date (e.g., every 30 seconds, 1 minute, 2 minutes, 5 minutes, etc.) or based on one or more triggering conditions being satisfied.

Some example triggering conditions include, but are not limited to, expiration of a timer, request from a different application or device, proximity to another device, entering and/or exiting a certain area or geographical location, a change to map data for map 126, a change to conditions used to generate route data 112, a change to the destination point, receiving a new destination point, etc.

Map data 116, in an embodiment, may describe one or more changes, alterations, additions, subtractions, and/or modifications to map 128. Map data 116 may be based on information in map 126 and/or obtained by map server 124. Over time, map and related road information may change, as new roads may be constructed, existing roads may be abandoned or fall into disrepair, traffic conditions may improve or worsen, and sometimes small incremental updates may be justified to improve the quality and appearance of existing roads on a map (e.g., slight adjustments to geometry, orientation, shape, and position of the road as displayed on map 128). Map data 116 may be provided by navigation server 120 to user device 102 in order to ensure that map 128 is up-to-date, and that any map changes are properly reflected in map 128 to enable accurate route guidance provision by navigation UI 106.

A transcoder module 132 on user device 102 is configured to decode route data 112, map data 116, and any other encoded/compressed data provided by server 118 to user device 102, in one embodiment. Moreover, transcoder module 132 is configured to encode descriptions of current navigation routes for transmission to server 118, within an update request 114 or separately, in various approaches.

A transcoder module 134 on server 118 is configured to encode route data 112, map data 116, and any other data provided by server 118 to user device 102, in one embodiment. Moreover, transcoder module 134 is configured to decode descriptions of current navigation routes from transmissions provided by user device 102, within an update request 114 or from separate messages, in various approaches.

In an embodiment, map server 124 may obtain one or more maps from another computing device, such as via network 130, retrieve a map from a local or remote storage device (not shown), or acquire a map according to any other method that supports generation of route data 112 and/or map data 116 by navigation server 120. Map 126 may have any suitable format and include any level of detail as is compatible with navigation server 120 and/or navigation application 104.

Moreover, map server 124 may be configured to analyze route and positional information received from user device 102 (e.g., in an update request 114) against map 120. Some example positional information includes, but is not limited to, a current location, a start point, a destination point, one or more segments of a route, etc.

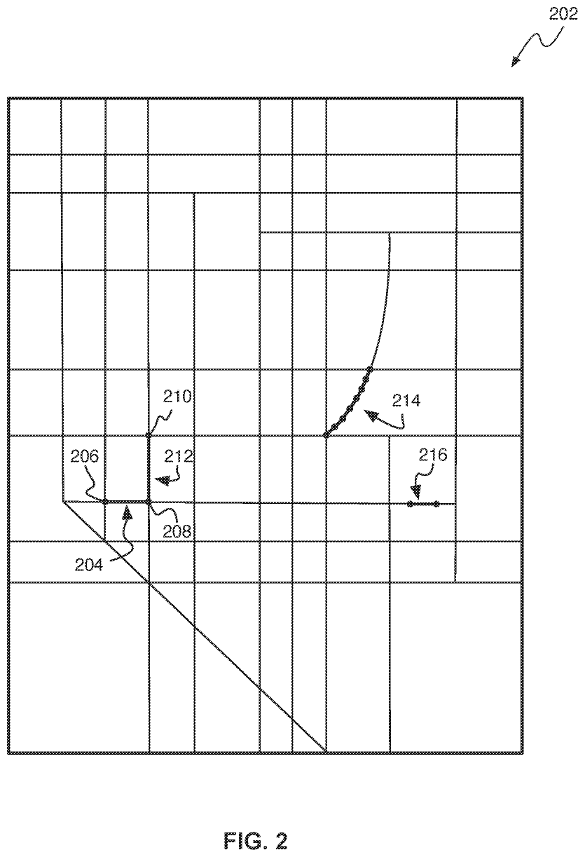

FIG. 2 illustrates an example map 202 with example segments. Maps typically are used to convey geographic and location information of a particular real-world area, and sometimes are configured to convey a certain aspect of an area, such as roads, trails, attractions, elevation, terrain, etc. A road map, such as map 202, is a graph representing a road network in the real-world by using vertices, junctions, or connecting points (e.g., 206, 208, 210) and segments (which describe at least a portion of a road connecting the points) to express the real-world road network. Multiple segments may combine to define a particular road (many-to-one, such as curved road 214 which is formed from multiple different segments), but a segment is not used to define multiple roads (e.g., one-to-many), according to one embodiment. In other words, segments describe a smallest granularity, portion, or section of a road that is able to be conveyed as substantially a line between two points (even if the line is slightly curved, it may be represented by lines in small enough increments), with the points being expressed as coordinates upon map 202.

In some cases, a segment may describe a particular portion of a road, even when the road continues as straight lines beyond either end point of the segment. For example, segment 216 describes a portion of a road having end points that do not coincide with an intersection between roads on map 202. There are many possible reasons for forming such a segment, including, but not limited to, placement of elements along a road (e.g., a crosswalk, pedestrian access, a stop sign, a yield sign, etc.), change in road class, change in number of lanes, change in speed limit, change in allowed travel direction(s) of the road, change in quality of road surface, etc. Any of these reasons may predicate that multiple segments be used to describe different unique portions of a road. The end points for the segments describing such a road may occur where conditions of the road change or an element is positioned along the road.

Each segment (e.g., segment 204, 212, 216) may be described by a set of attributes. The set of attributes for any given segment may be stored as metadata with the segment or stored in association with the segment within map data associated with map 202. Attributes may be stored (e.g., as metadata) with a corresponding segment in one approach. Attributes for one or more segments may be embodied as a separate group of data stored in conjunction with a set of segments (e.g., used to describe a map, a route, etc.) in another approach.

Some example segment attributes include, but are not limited to, an allowable travel direction (for a one-way street), allowable directions of travel (for bidirectional streets), a number of lanes for each allowable travel direction, a road class (e.g., freeway, highway, state route, residential street, dirt road, alley, bridge, etc.), a road size (a number of lanes in each allowable travel direction), time-based restrictions or enhancements (e.g., a road which increases in number of lanes during rush hour, a street which becomes one-way during the daytime, a road which is closed at night, a bridge which becomes one-way during rush hour, limitations of which type of vehicles may use the road, etc.), toll or use-fee information (e.g., toll or fee to use the road, time periods when toll is required/excused, etc.), and geometry information describing the location of the segment (e.g., an ordered list of coordinates for end points).

A junction includes one or more segments that coincide at the junction, with the number of segments coinciding at the junction being referred to as the degree of the junction (e.g., a two-degree junction has two segments connecting at the junction). The degree of the junction does not dictate an orientation of the junction. For example, a two-degree junction may correspond to end points for two segments which extend parallel to one another from the junction (e.g., a straight road) or a bend in a road where the segments extend at an angle from one another.

A route may be defined by an ordered list or set of points corresponding to segments on a map. The ordered set of points includes an origin or start point and an end or destination point. The order of the set of points describe a route from the start point to the end point. Many routes may exist between a set of start and destination points that traverse unique sets of segments therebetween. In one embodiment, attributes stored with each point in the ordered list of points may include coordinates for placement on a map. In an embodiment, the attributes may include identification of a segment that corresponds with the point, such as with a segment identifier.

As shown, segment 204 is defined as a straight line portion of a road between junction 206 and junction 208. Segment 212 is defined as a straight line portion of a road between junction 208 and junction 210. Therefore, junction 208 is a four-degree junction that serves as an end point for segment 204 and as an end point for segment 212.

Curved roads may be defined by many small segments that together approximate curvature of the road. In one embodiment, each segment may be short enough such that a user of the map is unable to perceive that multiple segments are used to form the curved road. For example, curved road 214 is described by a series of small segments that incrementally define the curved road 214, each small segment being a straight line between two points that are arranged in an ordered series that describes the portion of road 214 between the two junctions at either end of the series of segments.

Referring again to FIG. 1, map server 124 may receive description of a current route 108 in an embodiment. The description may be sent in the route request 110, or separately in another transmission (such as upon request by server 118). The description may describe route 108 using a series of support points corresponding to segments on map 128. The support points included in the description may be a subset of all points along route 108, and may be chosen to represent route 108 as a minimum set of points that can accurately convey route 108 to navigation server 120 (such as inflection points where the travel direction or bearing changes greater than a predetermined amount along route 108). Attributes may be included with the support points. These attributes may be characteristics of the segments corresponding to the support points such as coordinates, direction of travel, road class, etc. Each attribute may have a value associated with a specific characteristic to further define segments. For example, an attribute for direction of travel may have a value that represents that the direction of travel is only one way. In another example, latitude and longitude coordinates may be represented as two string variables, each having a fixed number of decimal places (such as seven decimal places of accuracy), along with separately stored positive/negative modifiers.

In a further embodiment, segment identifiers associated with segments of route 108 may be provided by user device 102, with each segment identifier indicating a particular segment and a direction of travel along the segment on map 128. The segments may be stored (e.g., as metadata) in the description of the current route 108 or provided in conjunction with the description for use in identifying which roads, directions of travel, and order of roads are included in route 108.

A segment identifier may be a numeric, alphanumeric, and/or character string that is capable of uniquely identifying a particular segment from any other segment of map 128, or any other previous or subsequent version of map 128. In this way, it is ensured that a segment identifier is not repeated or re-used in map 128 unless it identifies the exact same segment in a later or an earlier version of map 128.

To generate route data 112 to provide one or more routes in response to route request 110, route module 122 receives map 126 from map server 124 and at least the start point and end point from user device 102 for the requested route. Route module 122 uses map 126 to determine where roads, streets, routes, alleys, and other throughfares are located with respect to a current location of user device 102 in the real-world and a location of the destination point relative to the current location of user device 102. Route module 122 generates one or more routes which adhere to one or more conditions for traversing from the start point to the end point, and includes the route(s) in route data 112 that is sent back to user device 102. Navigation application 104 on user device 102 analyzes the route data 112 to determine a route 108 to provide guidance to a user for traveling to the destination point.

To provide accurate and up-to-date directions to user device 102, user device 102 may send an update request 114 to server 118. This update request 114 may include a description of the current route 108 (e.g., a set of support points along route 108 and associated attributes). The support points described for route 108 are a minimal set of points included in route 108 that may be used by server 118 to reconstruct route 108, without including all of the points along route 108.

Server 118 may generate updated route data 112 based on the description of the current route 108, current traffic conditions, relevant road closures, current position of user device 102, details included in map 126 (as compared to details of map 128), and/or other relevant information. In response to update request 114, server 118 analyzes route 108 from user device 102. The description of the current route 108 includes a start point (which corresponds to a current position of user device 102 on map 128) and a destination point that the user desires to travel to in the real-world.

Route module 122 is configured to analyze the start point, the destination point, and in some embodiments a series of segments identified by the description of the current route 108, against map 126 to determine if route 108 is optimal for transporting user device 102 to the destination point in accordance with one or more conditions. The conditions to satisfy in generating a best route may include, but are not limited to, a shortest distance, a shortest estimated travel time, avoidance of toll roads, minimizing turns, minimizing stops (e.g., due to features of the route such as stop signs, traffic lights, etc.), avoiding congestion and traffic, avoiding construction or lane closures, etc.

In case route 108 is still optimal for user device 102, server 118 may indicate to continue using route 108, but may update some other aspect of route 108, such as estimated travel time, distance traveled, distance remaining, etc. In an embodiment, server 118 may update map 128 on user device by sending over map data 116 that includes incremental changes to map 128 to synchronize with map 126 on server 118. Some example changes include, but are not limited to road closures, new roads, traffic conditions, geographical changes, road orientation adjustments, etc.

Server 118 responds to update request 114 with updated route data 112 responsive to one or more routes having one or more advantages over current route 108. These advantages may correspond to one or more conditions used in determining the best route, such as being shorter in length, having a shorter estimated travel time, using less toll roads, requiring less turns, requiring less stops, avoiding congestion and traffic, etc.

In another embodiment, route module 122 may generate routes based on a series of segment identifiers corresponding to segments upon map 128 used to generate the description of the current route 108. Route module 122 will generate a corresponding series of segments to describe one or more better routes, and respond to the request by encoding the better route(s) in updated route data 112.

In one embodiment, the route data may include an encoded route, which may comprise indication of at least a subset of all points along the route (referred to as support points) corresponding to segments which describe the route without including all attributes of each support point or all points along the route. For example, an encoded route may include a series of support points and associated segment identifiers which correspond with a series of segments which describe the route, where the series of support points are junctions between pairs of segments in the series of segments. In some approaches, attributes may be included for at least some of the support points along the route. The series of segment identifiers are arranged in a way that describes each segment that is to be traversed in order, starting at the start point and ending at the destination point, in an embodiment.

In an embodiment, an optimal route, for any set of conditions, between an origin point and a destination point is a route that minimizes a calculated cost induced by a cost function directed toward the set of conditions when traversing the series of segments that define a route from the origin (start) point to the destination (end) point. The set of conditions may dictate a shortest route, in one embodiment. Any suitable cost function may be used for such calculation, such as by executing Dijkstra's algorithm which has a runtime of O(m+n*log n), where m denotes the number of segments in the route, and n is the number of vertices of the graph (map). Note that there might be multiple shortest routes between any two points that have the same minimum cost. Selection of which of these shortest routes to use may be based on one or more other conditions besides shortest distance, such as estimate travel time, reduction of congestion or traffic, minimizing a number of stops, etc. Another common graph traversal algorithm for computing the cost function is a depth-first search (DFS) which may be used to determine a route which satisfies the one or more conditions. Although DFS traversal cannot find the shortest path, in some implementations the DFS traversal can be altered to sort vertices based on their deviation from going straight ahead on a path and exploring vertices which continue straight ahead first.

One or more routes may be sent to user device 102 in route data 112 as a series of segment identifiers and associated attributes. In some implementations, attributes for each successive segment identifier may relay differential information based on a previous segment identifier, rather than relaying an entire set of geolocational information for each segment identifier in the series. This relaying of differential information is useful for updating an existing route 108 in user device 102 to conserve processing and transmission resources.

The set of routing points in the route data 112 are sufficient to reconstruct a route given a map 128 on which the transcoder module 132 can operate. However, there are scenarios where the map 128 is not available or is incomplete, or decoding the whole route would be too costly in case the map 128 is not fully offline and updates/downloads via the network 130 are needed.

In order to draw a route onto the map 128 to display on user device 102, additional geometry information may be sent in-between the routing points (referred to as “geometry points”). The route data stores coordinates for the geometry points, but no other data like corresponding segment identifiers, since they are not required for decoding the route using the transcoder module 132. The geometry is automatically simplified, according to a configurable threshold, so that a curvature may be approximated by a controllable amount of geometry points. Compression is useful to keep transmission size as low as possible.

According to one or more embodiments, a compression algorithm or scheme may be used to encode and losslessly compress route data 112, map data 116, and/or a description of a current navigation route from user device 102, in order to reduce transmission size between user device 102 and server 118.

For storing coordinates, delta encoding to point i−1 is used (i.e., only the very first point is stored with the full coordinates, and for any subsequent point i, only a delta of +/−latitude and longitude is stored). These deltas may be encoded with a Golomb-Rice (or Rice) code or another similar code.

The route data and route descriptions may be encoded and compressed prior to transmission to reduce the number of bits needed to store the differential information (e.g., deltas for +/−changes in latitude and +/−changes to longitude from a previously provided position). In one embodiment, signs (positive and negative) of the deltas for latitude and longitude may be stored separately, a decision that is derived from knowledge that changes to the signs do not occur frequently for longer routes.

For example, if you travel from San Francisco, Calif. to Lake Tahoe, Calif., a vast majority of the route is directed north-east, so the signs for both the latitude deltas and longitude deltas will be positive for most of the route (positive indicating northward and eastward directions, negative indicating southward and westward directions). Therefore, instead of storing the sign bit for all points in a route (which may include thousands of points for such a route to allow user device 102 to reconstruct the route upon receipt from server 118), the sign bit for the first point is stored, as well as the delta to the next point index where the sign changes. If the sign does not change for the entire route (e.g., the route is only directed north-east for the entirety of the route), only the very first sign is stored, saving the space required to store additional single bits for each point in the route description.

Latitude and longitude deltas and positional information may be stored and transmitted using seven decimal places to allow for more precise representation of routes, roads, and features on the maps, along with higher accuracy when decoding route data (e.g., reducing decoding errors) as compared to other commonly used schemes or libraries.

Navigation Interface

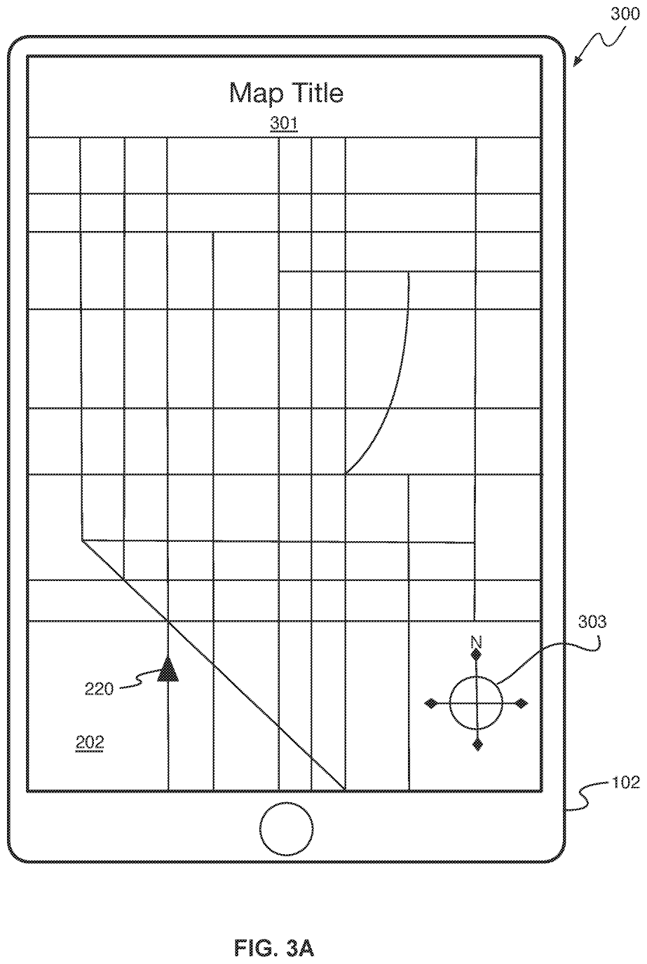

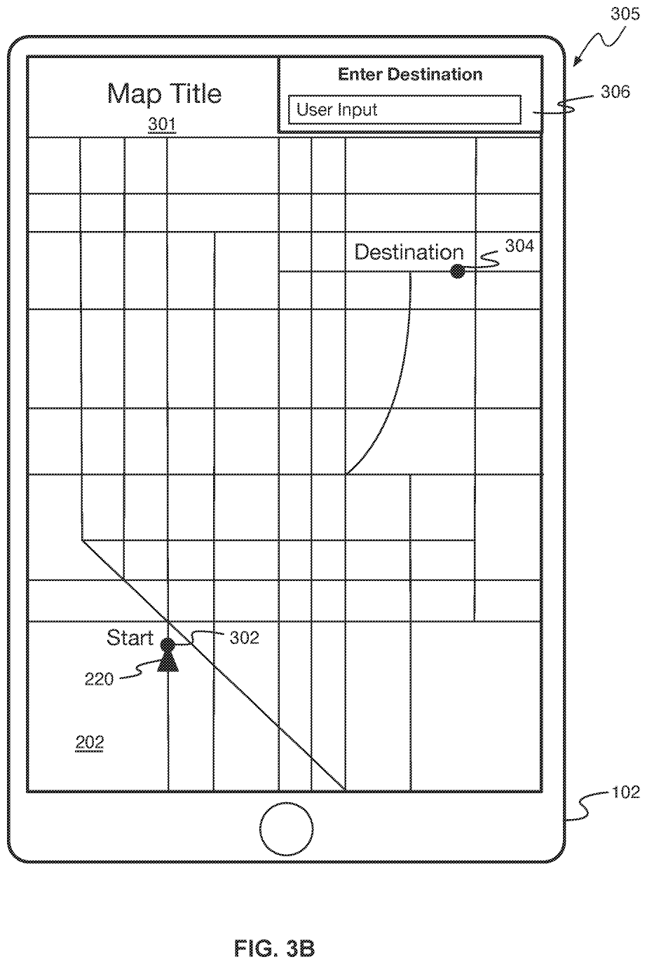

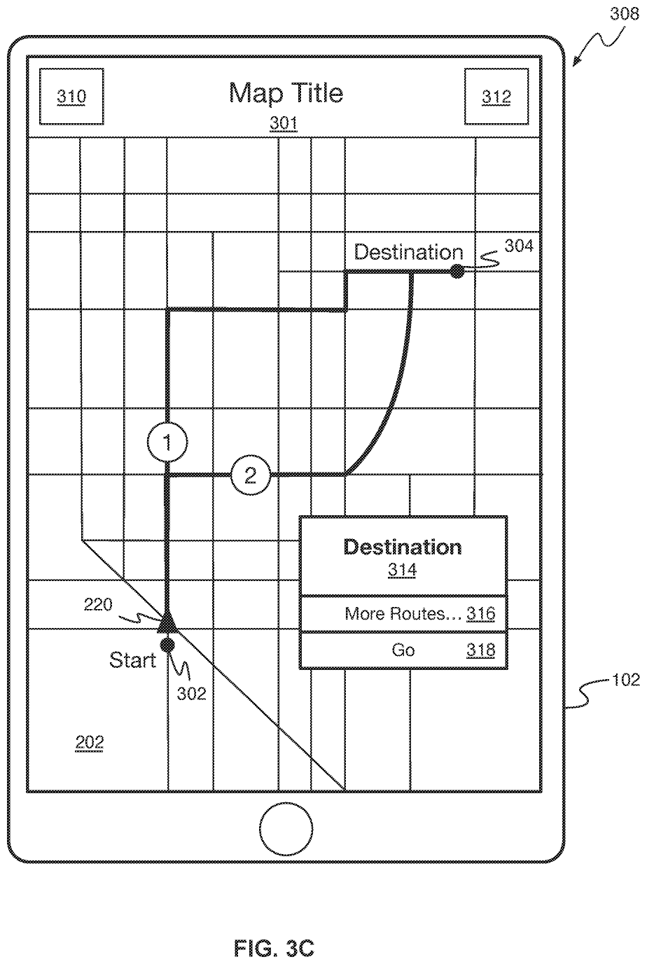

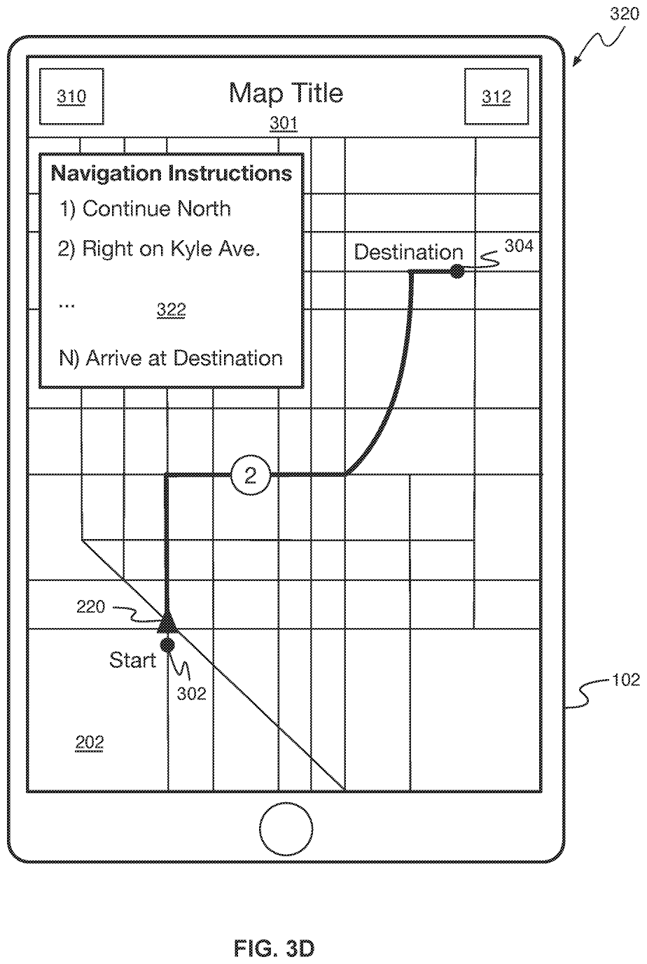

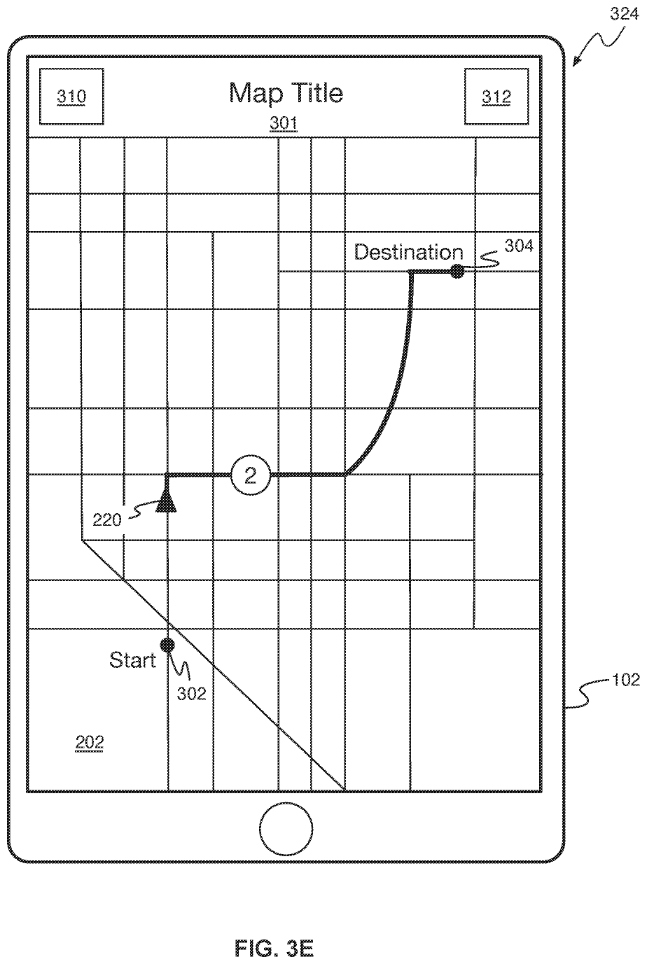

FIG. 3A shows an example navigation user interface 300 for providing navigational information for use with a user device 102. Interface 300 displays map 202, a compass rose 303 depicting geographical directions (north, south, east, west), and a map title 301 for relaying information about map 202 (e.g., current location, desired destination location, etc.). Navigation interface 300 also shows a current position indicator 220 that indicates a current position of the user device 102 shown on map 202 at a corresponding location based on navigational positioning information obtained by user device 102, such as a location in the real-world obtained through a GPS device of user device 102.

Navigation interface 300 is configured to receive user input (e.g., using a touch screen display, physical controls, physical knobs, physical buttons, voice input, etc.) that corresponds to a command that is recognized by a navigation application, such as navigation application 104 in FIG. 1. In response to the user input to navigation interface 300, navigation application processes input data corresponding to the user input to determine which graphical elements (e.g., controls, buttons, list item, directional control, keys, text, sliders, etc.) presented on navigation interface 300 were selected by the user. Navigation application may respond appropriately to the user input. Some example responses include, but are not limited to, changing the map 202, moving a currently displayed position on map 202, displaying an input field (such as for entering a destination), rotating a view of map 202, canceling a previously-entered destination, etc.

FIG. 3B is an example user interface 305 for providing a navigation route on a user device 102. User interface 305 displays an input field 306 for inputting a destination. Input field 306 may be displayed in response to selection of a graphical element in one approach. The user may then input a destination description or address into input field 306 via any input method. Some example input methods include, but are not limited to, keyboard (physical or virtual), voice control, copy and paste, direct selection on map 202, etc. Once the destination is entered in input field 306, user interface 305 shows a start point 302 (which coincides with a current location of user device as indicated by current position indicator 220) and a destination point 304 corresponding to the user input. Moreover, user device 102 sends a request for a route to travel from start point 302 to destination point 304 to a server.

FIG. 3C is an example user interface 308 showing two navigation routes for traveling to the destination point 304. There may be many different routes to travel from start point 302 to destination point 304, but only a predetermined number of top choices may be displayed (e.g., two routes, three routes, four routes, five routes, etc.), in one embodiment. In FIG. 3C, two routes are displayed: Route 1 and Route 2. The user may select one of these two routes for receiving navigational instructions to travel to the destination via navigation interface 308.

Navigation interface 308 may display additional graphical elements to help the user navigate user interface 308. Some example graphical elements shown on user interface 308 include map title 301 for relaying information about map 202, label 314 for the chosen destination point (e.g., address for the destination, name of the destination, nickname for the destination, etc.), selectable element 316 that causes additional routes to the destination point 304 to be determined and/or displayed on map 202, selectable element 318 that causes navigation application to clear map 202 of all previewed routes (e.g., by removing unselected routes) and begin route guidance for a selected route to the destination (such as by presenting updated map views for each step of travel from start point 302 to destination point 304, and in some cases along with informational elements, alerts, and/or other content related to traveling along the selected route), and content-specific selectable elements 310 and 312 which may be specific to currently-displayed content or universal across multiple user interfaces.

Some example functions that may be performed in response to selection of selectable elements 310 and 312 include, but are not limited to, moving back through guidance for a selected route, moving forward through guidance for a selected route, an overview that causes a detailed view of a selected route to be presented, muting/unmuting audible guidance instructions, switching a level of detail for map 202, zooming in/out, etc.

In response to user selection of selectable element 316 to view more routes, a route preview panel may be displayed that presents a route list that includes at least Route 1 and Route 2, along with information about alternate routes for reaching the selected destination. For example, navigation application may provide information on each route, including a name, distance, and estimated travel time. Each time the user chooses to preview a route (e.g., selects a new or different route from the route list), navigation application may update user interface 308 to provide a visual representation (e.g., preview) of the route. For example, navigation application may highlight (e.g., change color, use bold or thickened lines, etc.) the roads included in the selected route, flash or blink the roads in the selected route, etc. If more routes are available than can be shown on map 202, a selectable element (not shown in FIG. 3C) may be shown automatically, allowing the user to preview additional routes.

FIG. 3D is an example user interface 320 for providing navigational guidance for a selected route. In FIG. 3D, the user has selected Route 2 for guidance to the destination. In response to this selection (and/or selection of element 318 from FIG. 3C), user interface 320 highlights the roads along Route 2. In one embodiment, user interface 320 may display graphical element 322 for providing turn-by-turn route guidance from start point 302 to destination point 304. The turn-by-turn route guidance may be populated with content by navigation application for display in graphical element 322 of user interface 320. As user device 102 moves in the real-world, current position indicator 220 moves on map 202 in accordance with movement in the real-world.

For example, navigation application may provide information describing upcoming maneuvers along the selected Route 2. Navigation application may configure graphical element 322 to show from two up to as many upcoming maneuvers as exist in the selected Route 2. Each maneuver presented in graphical element 322 may include maneuver information, such as an icon, text, distance, and/or travel time. In addition to presenting upcoming maneuvers in graphical element 322, navigation application may configure graphical element 322 to present travel estimates (e.g., arrival time, travel time remaining, miles remaining, etc.) for the overall trip along Route 2 and/or for each step in Route 2. For example, navigation application may continuously update the travel estimates while the user is traversing the selected Route 2.

FIG. 3E is an example user interface 324 for providing navigational guidance for selected Route 2. As shown, user device 102 has traversed a portion of Route 2, resulting in current position indicator 220 to be correspondingly moved along Route 2. In addition, in one embodiment, a previously traversed portion of Route 2 is no longer highlighted, to simplify user interface 324 and make it simpler for the user to discern the remaining route ahead.

FIGS. 3A-3E show example user interfaces, and many other possible orientations and arrangements for user interfaces may be used in conjunction with the embodiments disclosed herein, including the use of more or less graphical elements, map views, functionality, etc.

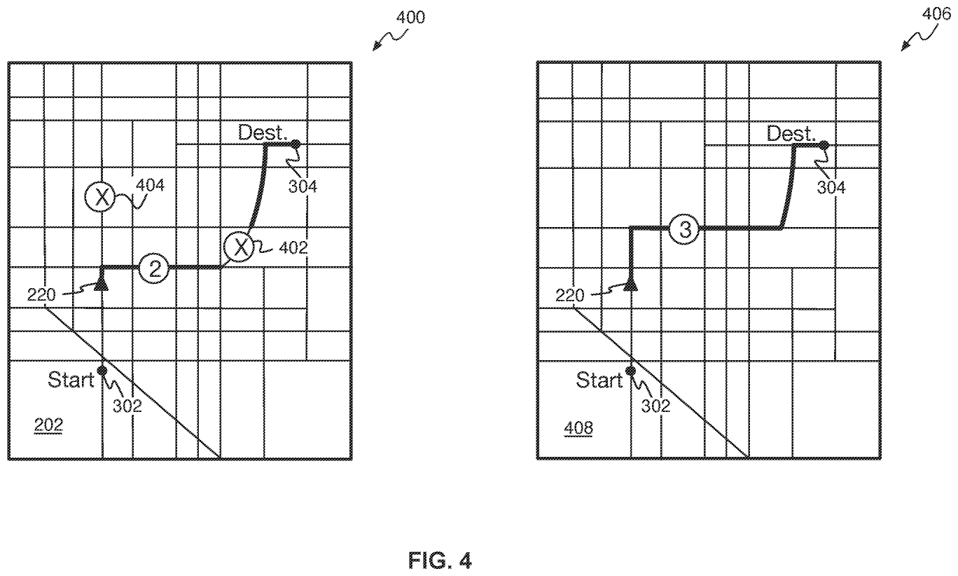

FIG. 4 illustrates example modifications to a map based on updated road information. Road information may change over time, as new roads may be constructed, existing roads may be abandoned or fall into disrepair, traffic conditions may improve or worsen, and sometimes small incremental updates are needed to improve the quality and appearance of existing roads on the map (e.g., slight adjustments to geometry, orientation, shape, and position of the road as displayed on the map).

In FIG. 4, updated road information is obtained by a server. In this example, the updated road information indicates that several roads have been closed or otherwise rendered impassable, indicated as closures 402 and 404 in user interface 400. In one embodiment, a currently-used map, e.g., map 202, may be updated with closures 402 and 404 in user interface 400. Selected Route 2 shown on user interface 400 includes a road that traverses through closure 402. As a result, the server may update map 202 to remove portions of roads affected by the closures, shown as map 408 in user interface 406. In addition, because Route 2 traverses through closure 402, the server may determine a new route that avoids closure 402 (and closure 404 if necessary) to traverse from the current start point (corresponding to current position indicator 220) to destination point 304. To generate this new route, the server may perform any route generation method as described in embodiments herein. The server may convey other updates to the user device based on the updated road information, such as estimated travel time, estimated distance traveled, estimated distance remaining, etc.

This new route is shown as Route 3 on map 408 in user interface 406. As road conditions change and updated information is obtained by a server, map 408 may be further updated and/or new routes may be generated in order to provide an optimal route to traverse to destination point 304. The previously described conditions may be considered in calculating the optimal route.

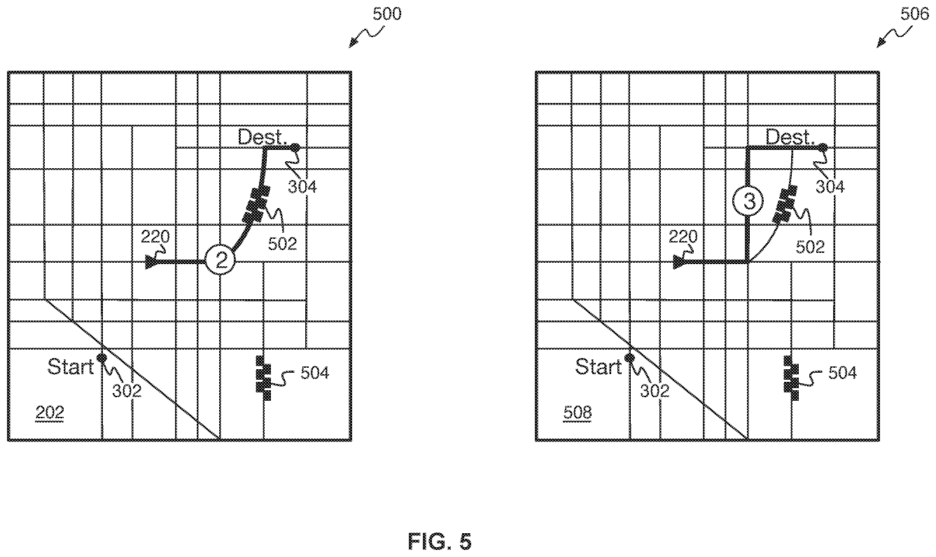

FIG. 5 illustrates example modifications to a map based on updated road information. In one example, a server, such as server 118 in FIG. 1, may obtain updated road information relating to increased traffic levels and/or congestion on particular portions of roads in map 202, shown as congestion 502 and congestion 504 on user interface 500. Selected Route 2 is being followed by the user device, and it includes a road that traverses through congestion 502 before arriving at destination point 304. As a result, the server may update map 202 to indicate the congested portions of roadways with congestion 502 and congestion 504 as shown in user interface 506. In another embodiment, the server may provide a new map 508. In addition, because Route 2 traverses through congestion 502 in this example, the server may determine a new route that avoids congestion 502 (and congestion 504 if necessary) by utilizing a different road to traverse from the current start point (corresponding to current position indicator 220) to destination point 304. To generate this new route, the server may perform any route generation method as described in embodiments herein. The server may convey other updates to the user device based on the updated road information, such as estimated travel time, estimated distance traveled, estimated distance remaining, etc.

The new route is shown as Route 3 on map 508 in user interface 506. As road conditions change and updated information is obtained by the server, map 508 may be further updated and/or new routes may be generated in order to provide an optimal route to traverse to destination point 304. The previously described conditions may be considered in calculating the optimal route.

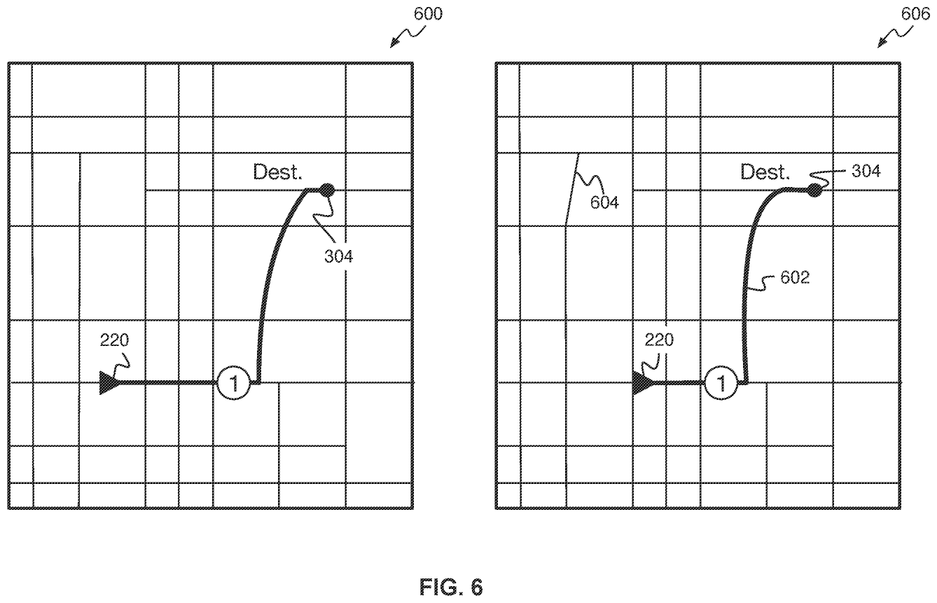

FIG. 6 illustrates example modifications to a map based on updated road information. In one example, the server may obtain updated road information relating to the geographical representation of particular roads in map 600, shown as roads 602 and 604 in map 606. Selected Route 1 that is being followed by the user device traverses road 602 before arriving at destination point 304. However, because the geographical representation of road 602 does not affect Route 1 as being the optimal route for the user device (according to a set of conditions, like fastest route), the server updates map 600 to indicate the reoriented position of road 602 on map 606, but does not adjust Route 1. In addition, the server updates road 604 on map 606 to reflect a slight bend in the road instead of being represented as a straight road as on map 600 in response to receiving information indicating that the orientation of road 604 was inaccurate. The server may convey other updates to the user device based on the updated road information, such as estimated travel time, estimated distance traveled, estimated distance remaining, etc.

As road conditions change and updated information is obtained by the server, map 606 may be further updated and/or new routes may be generated in order to provide an optimal route to traverse to destination point 304. The previously described conditions may be considered in calculating the optimal route.

### Example Processes

To enable the reader to obtain a clear understanding of the technological concepts described herein, the following methods describe specific steps performed in a specific order. However, one or more of the steps of a particular method may be rearranged and/or omitted while remaining within the contemplated scope of the technology disclosed herein. Moreover, different methods, and/or steps thereof, may be combined, recombined, rearranged, omitted, and/or executed in parallel to create different method flows that are also within the contemplated scope of the technology disclosed herein. Additionally, while the methods below may omit or briefly summarize some of the details of the technologies disclosed herein for clarity, the details described in the paragraphs above may be combined with the method steps described below to get a more complete and comprehensive understanding of these methods and the technologies disclosed herein.

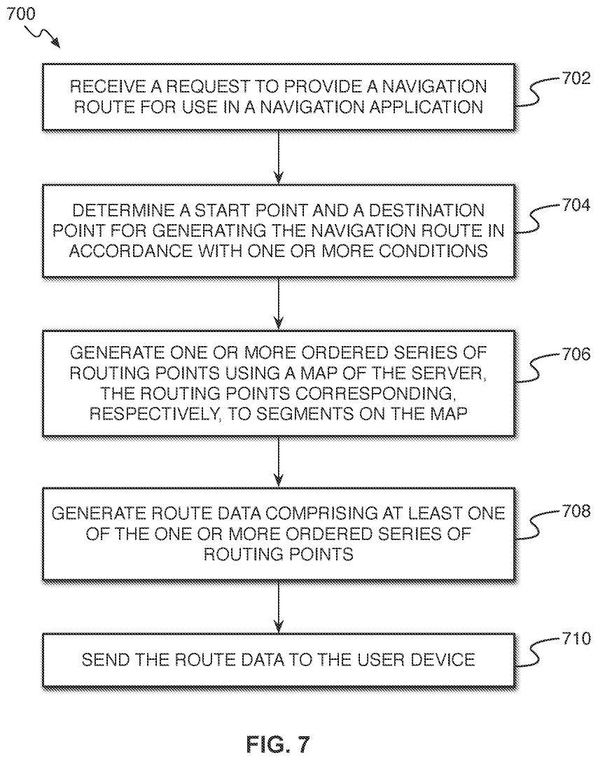

FIG. 7 is a flow diagram of an example method 700 for generating a navigation route for use with a navigation application on a user device. For example, method 700 may be performed, with reference to FIG. 1, by server 118 to generate route data 112 using a map provided by map server 124 for use by user device 102 in a navigation application 104. Method 700 will now be described with continued reference to FIG. 7.

At operation 702, a server receives a request to provide a navigation route to a user device for use in a navigation application. The request may be sent via one or more networks from the user device to the server, in an approach. The request may be sent to begin a new route and/or in response to a triggering condition being satisfied.

In one embodiment, the request may include a start point and a destination point. Further, the request may include associated metadata configured to allow for placement of the start and destination points upon a map, even in the case where the map on which the start and destination points are intended to be decoded (e.g., the map on the server) was not used to define the start and destination points (e.g., the map on the user device).

At operation 704, the server determines the start point and the destination point for generating the navigation route between the points. This information may be obtained from the request, from another transmission received after the request, or from a remote storage device accessible to the user device and the server, such as cloud-based storage.

In an embodiment, the navigation route may be generated based on one or more conditions. The conditions may be provided by the user device, by the server, as a default set, provided by the navigation application, or dictated by some other device or application. The conditions may include, but are not limited to, a shortest distance, a shortest estimated travel time, avoidance of toll roads, minimizing turns, minimizing stops (e.g., due to features of the route such as stop signs, traffic lights, etc.), avoiding congestion and traffic, avoiding construction or lane closures, etc.

At operation 706, the server generates one or more ordered series of “routing points” using a map of the server. The routing points for any particular ordered series are a subset of points selected from all points along a corresponding candidate route. The points in an ordered series are selected to provide sufficient detail of the candidate navigation route for the user device to reconstruct the navigation route using a map of the user device without including all the points, to reduce transmission bandwidth requirements and processing resources at the user device.

The routing points included in any particular candidate navigation route correspond to segments for that candidate navigation route on the server's map. Each segment may be indicated by a segment identifier in an approach.

At operation 708, the server generates route data that includes at least one of the ordered series of routing points. In an approach, the route data may also include attributes for each of the routing points in each of the ordered series of routing points, such as coordinates, corresponding segment identifier, travel direction, road class, etc. The ordered series of routing points describe a navigation route from the start point to the destination point. In one embodiment, a series of segment identifiers corresponding to at least one of the candidate navigation routes may be provided in addition to the ordered series of routing points for the candidate navigation route.

At operation 710, the server sends the route data to the user device. One or more networks may be utilized to transmit the route data, or the route data may be sent directly to the user device.

A route-codec library may be used by the server and the user device to encode a navigation route as route data. The server may store a consecutive list of “routing points” corresponding to segments on its map. Each routing point may be encoded to include coordinates, a bearing of the underlying segment at that exact location (e.g., in degrees from North), a road class description, a distance from the route's start point, and a unique identifier for the segment. This segment identifier is unique in the sense that no other segment on the same map, but also any other previous map version, has the same segment identifier. The segment identifier also encodes a direction of movement along the segment.

In one embodiment, the server is configured to determine a complete route (e.g., a full set of points, one point for each segment in the route) that has a geometry to be reproduced on a map of the user device. Once the complete route is determined, the server generates a simplified route for transmission to the user device that is able to be described with less points (and corresponding segments). This reduced set of points is referred to as “routing points,” and are selected to ensure that the user device can reconstruct and draw the geometry of the complete route. The user device should be able to draw the geometry of the route using the set of routing points, corresponding segments, and attributes for each routing point provided by the server.

To perform this reduction, the server reduces the full set of points in a way that still conveys the full geometry of the route to the user device. In other words, the server reduces the complete route into a simplified route which comprises sufficient information to allow the user device to reconstruct and draw the navigation route as an overlay on the user device's map. To provide sufficient information, the server selects a reduced set of “routing points” from the full set of points that still allow the user device to draw the route using corresponding segments of the user device's map.

The server selects the routing points from the full set of points such that each routing point describes a change in the geometry that should be described to the user device for proper reconstruction (e.g., where bends, turns, segment changes, etc., take place in the route). This process allows the server to provide a smaller data set describing the route for transmission to the user device. The start and destination points are included in the routing points since they are needed to accurately place the origin and destination on their respective segments.

In one embodiment, starting from the origin, the server iterates over the segments of the complete route in order. At each segment i, the server checks whether the transcoder module on the user device would find segment i from the previous segment i−1. If that is the case, no routing point is needed for segment i; otherwise, a routing point is added with the data from segment i.

Whether the transcoder module on the user device would find segment i from segment i−1 is determined by checking the reachable segments at the junction separating the two segments. One consideration is whether segment i is the only segment that has a deviation from straight of less than a preconfigured angle (e.g., 0.5 degree, 1 degree, 5 degrees, etc.). In this case, a routing point is not added. Another possible consideration is whether a routing point has been placed for a predetermined distance (e.g., 1 km, 5 km, 10 km, etc.). If no routing point has been added for more than the predetermined distance, the server adds a routing point. The addition of intermediate routing points based on more than the predetermined distance existing between routing points may be selectively enforced (such as with a setting on the server) or based on whether a fixed upper bound on a maximum distance between routing points is specified on either transcoder module.

This route generation and encoding approach usually results in a smaller number of routing points (lower hundreds) and allows the user device to reconstruct the complete geometry of the complete route using less points of reference than used to describe the complete route.

As discussed previously, a compression algorithm or scheme may be used to encode and losslessly compress route data, in order to reduce transmission size to a user device. For storing coordinates, delta encoding to point i−1 is used (i.e., only the very first point is stored with the full coordinates, and for any subsequent point i, only a delta of +/−latitude and longitude is stored). These deltas may be encoded with a Golomb-Rice (or Rice) code, or another similar code.

The route data and route descriptions may be encoded and compressed prior to transmission to reduce the number of bits needed to store the differential information (e.g., deltas for +/−changes in latitude and +/−changes to longitude from a previously provided position). In one embodiment, signs (positive and negative) of the deltas for latitude and longitude may be stored separately, a decision that is derived from knowledge that changes to the signs do not occur frequently for longer routes.

Decoding the encoded route on the user device from route data that includes a set of routing points may be performed by placing the ordered series of routing points and associated segments upon the user device's map. Once the segments are aligned with the user device's map, the route may be drawn or overlaid on the map for display to a user. In a further approach, should the segments not align with information in the user device's map, shortest-route queries between each consecutive routing point pair in the encoded route may be performed to reconstruct the navigation route provided to the user device. However, the set of routing points are selected by the server to ensure that the user device is able to reconstruct the determined route without performing any further analysis.

Most map data providers have such an identifier scheme, and therefore custom maps are not needed to perform the embodiments described herein. Storing the unique segment identifier within the encoded route allows for reduced decoding resources and less transmission bandwidth needed to achieve a similar level of decoding error rate as other, more resource-intensive techniques.

This provides the advantage that no map-matching of a support point based on its coordinate and attributes is performed when decoding the route. This results in faster decoding (using a single lookup in constant time) and 100% accuracy. In case the segment identifier is not found in the map data used by the decoding device, the codec library dictates that map-matching similar to other libraries be used. For the start point and destination point of any determined route, the codec library dictates that the decoding device project these points' location onto the first and last segment, respectively.

In modern navigation services, map data is updated at least daily, and sometimes more often. However, the amount of churned segments is insignificant (i.e., new segments added, old segments deleted). Therefore, relying on the segment identifiers is effective since a vast majority of the time, looking up a segment using its segment identifier returns a result and map-matching is not required.

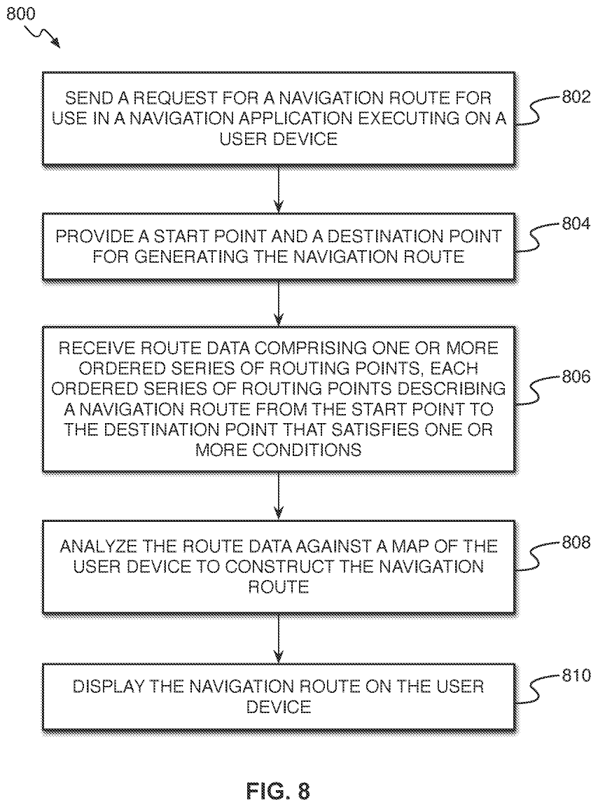

FIG. 8 is a flow diagram of an example method 800 for decoding a route for use with a navigation application on a user device. For example, method 800 may be performed, with reference to FIG. 1, by user device 102 to decode an encoded route from route data 112 for use by navigation application 104. Method 800 will now be described with continued reference to FIG. 8.

At operation 802, a user device sends a request for a navigation route for use in a navigation application. The request may be sent via one or more networks from the user device to a server, in an approach. The request may be sent to begin a new route, and/or in response to a triggering condition being satisfied.

At operation 804, the user device provides a start point and a destination point for generating the navigation route. In a further approach, the user device may provide a series of segment identifiers that describe a current navigation route being used by the navigation application, when appropriate. In addition, in some approaches, the user device may provide a consecutive list (e.g., ordered series) of support points along the current navigation route.

At operation 806, the user device receives a route data (e.g., from the server). The route data comprises one or more ordered series of routing points, each ordered series of routing points describing a navigation route from the start point to the destination point. In a further approach, each of the ordered series of routing points describe a candidate navigation route that satisfies one or more conditions, as described previously.

In an embodiment, the route data may include a series of segment identifiers corresponding to at least one of the ordered series of routing points, the segments traversing one of the candidate navigation routes.

At operation 808, the user device analyzes the route data against a map of the user device to construct a corresponding navigation route.

In one or more embodiments, given a consecutive list (e.g., ordered series) of routing points, a transcoder module of the user device may begin decoding by identifying the segments that correspond to the routing points. To this end, the user device may look up the segment identifiers of the routing points against the map data available to the user device (which may be different than the map data used to encode the routing points originally). In case the segment identifier is not found, the user device will rely on map-matching, as described above. This involves snapping the routing point's coordinate onto the map, with the added insight of any additional attributes, like road class, bearing, etc., to identify the correct segment.

Note that in contrast to the segment identifier lookup, the map-matching process may cause errors. If this happens, the user device will try to decode the received navigation route, but may fail. Each routing point may have more than one segment candidate in the case of map-matching. For example, two very short segments may both be the correct segment in case the routing point is close to the intersection incident to the two segments, which is indiscernible in map-matching.

Once all segments corresponding to the routing points have corresponding segments identified, the user device retrieves the remaining segments in between the routing points to fully reconstruct the received navigation route. This is done by running an algorithm similar to DFS between each adjacent routing point pair. At every intersection, outgoing segments that would result in a deviation from straight larger than the predetermined maximum (e.g., 10 degrees) are discarded. The threshold for the predetermined maximum should correspond to the threshold used in the encoding stage. In other words, the search space is pruned or restrained. The segments with a smaller deviation from straight are sorted by increasing angle and put onto the DFS stack in that order. In this way, the segment with the smallest angle is followed first.

Due to map changes, the angle between segments may become greater or become lesser. A greater angle may result in a previously selected segment pair that was below the threshold now being above the threshold. However, in case there were more than one segment, this would have caused a support point in the encoding of the navigation route. If the angle becomes lesser, additional candidate segments may be made available than before, which is why the segment with the smallest angle is not simply chosen, but the process allows for all segments that result in an angle below the threshold to be considered.

At operation 810, the navigation route is displayed on a screen of the user device, such as via navigation application and as described in various embodiments herein.

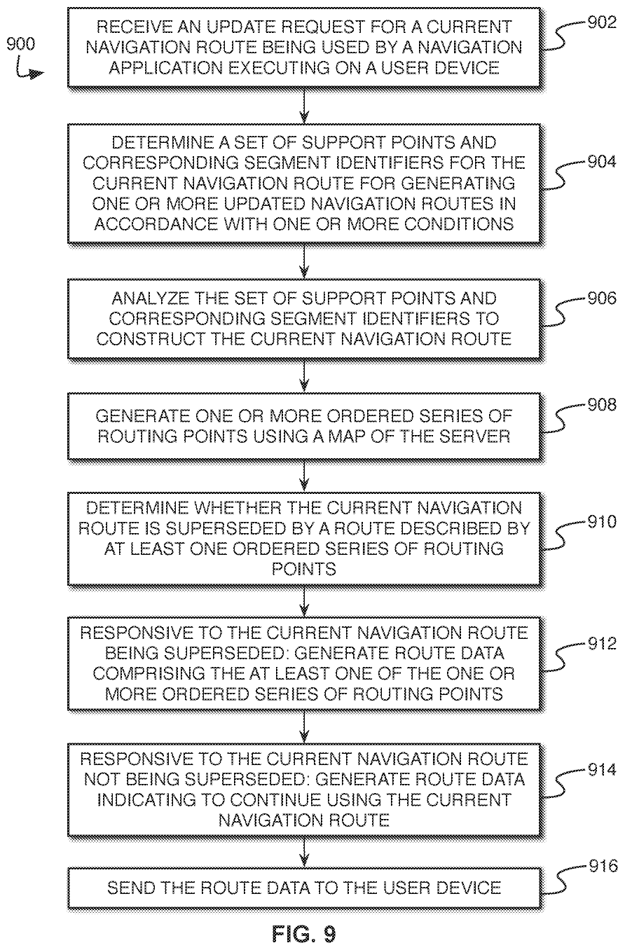

FIG. 9 is a flow diagram of an example method 900 for updating a navigation route being used by a navigation application on a user device. For example, method 900 may be performed, with reference to FIG. 1, by server 118 in response to receiving a request from user device 102. Method 900 will now be described with continued reference to FIG. 9.

At operation 902, the server receives an update request for a current navigation route being used by a navigation application executing on a user device. The update request may be received periodically, in response to a triggering condition, etc.

At operation 904, the server determines (e.g., obtains, reads from memory, receives, etc.) a set of support points and corresponding segment identifiers for the current navigation route. The set of support points and corresponding segment identifiers may be used to reconstruct the current navigation route being used by the user device. Moreover, this information may be used to generate one or more updated navigation routes in accordance with one or more conditions. The set of support points includes a start point and a destination point to allow for construction of the current navigation route at the server.

In one embodiment, in order to conserve resources and minimize a size of the data set for transmitting information to reconstruct the current navigation route, each point in the set of support points is selected to be encoded in the description of the route because it occurs at an intersection of segments where an angle of intersection is greater than a threshold angle (e.g., 1 degree, 5 degrees, 10 degrees, 15 degrees, etc.). The threshold angle may be set by the user device and/or server in order to obtain a desired size of data set for use in transmitting information about the current navigation route to another device without utilizing excessive bandwidth, but still allowing the other device to determine the current navigation route from the reduced subset of points (the support points, which include the start and destination points).

At operation 906, the server analyzes the set of support points and corresponding segment identifiers to construct the current navigation route on a map of the server. In a further embodiment, the server determines all segments which combine to describe the current navigation route, each segment being a connector between two support points that are identifiable on a map by a corresponding segment identifier. The server may further determine attributes for the support points, such as a corresponding coordinate, traversal direction, inflection angle, etc. These attributes may be stored as metadata with the set of support points, in an approach.

At operation 908, the server generates one or more ordered series of routing points using the map of the server. The routing points correspond, respectively, to segments on the map. In addition, the one or more ordered series of routing points and corresponding segments each describe a route from the start point to the destination point according to the one or more conditions.

When the server sends route data about a navigation route to a user device, the server may send a more complete set of routing points to the user device (as opposed to the support points which were received to describe the current navigation route). This more complete set of points (which includes more points along a navigation route than would be encoded by a user device, but not all of the set of points available to the server) allows the user device to reconstruct the navigation route in the navigation application without performing all of the processing that takes place on the server. In this way, the server may offload some of the processing burden from the user device, minimize transmission size, provide a visually complete and accurate representation of the navigation route for a map of the user device, and ensure 100% decoding success of the navigation route on the user device.

At operation 910, the server determines whether the current navigation route is superseded by a route described by at least one of the one or more ordered series of routing points. This determination is made based on one or more conditions for generating navigation routes, such as shortest distance, fastest to traverse, avoidance of traffic or congestion, avoidance of stops, etc. Should one of the candidate navigation routes surpass the current navigation route with regard to the one or more conditions (e.g., being shorter, faster, etc.) stipulated by the search algorithm, the better route may be selected for use with the user device.

At operation 912, responsive to determining that the current navigation route is superseded by another navigation route (e.g., a better navigation route exists), the server generates route data comprising the at least one of the one or more ordered series of routing points which surpassed performance of the current navigation route with respect to the one or more conditions.

At operation 914, responsive to determining that the current navigation route is not superseded by another navigation route (no better navigation routes exist), the server generates route data indicating to continue using the current navigation route (or in some cases sends back route data that allows for construction of the same navigation route by the user device).

At operation 916, the server sends the route data to the user device. In an embodiment, the route data may include one or more encoded navigation routes that comprise identification of a series of support points (including the start point and the destination point), and in some approaches, corresponding segments therebetween. The segments may be identified using segment identifiers that may be used to uniquely identify the various segments regardless of the version of map being used to decode the encoded route.

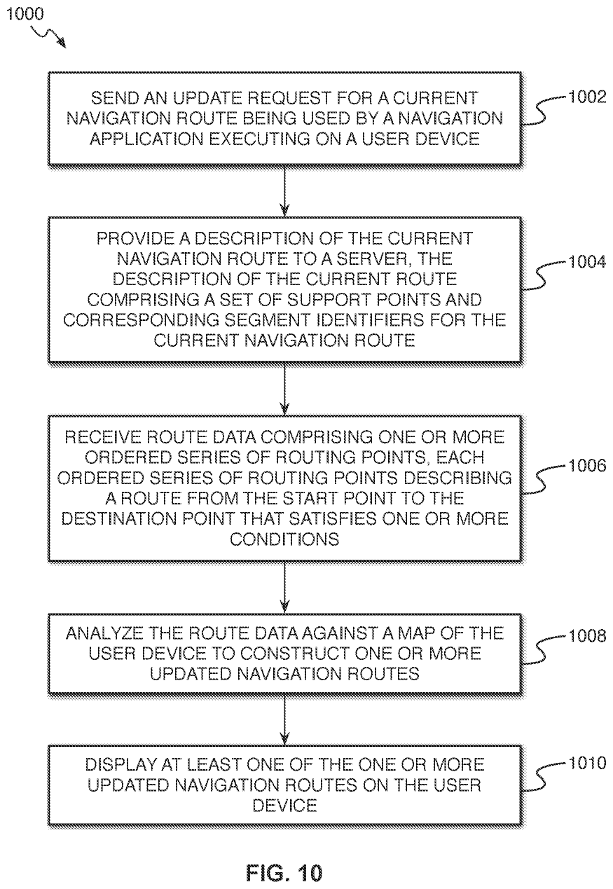

FIG. 10 is a flow diagram of an example method for requesting an updated navigation route for use with a navigation application on a user device. For example, method 1000 may be performed, with reference to FIG. 1, by user device 102 to request an updated navigation route from a server 118. Method 1000 will now be described with continued reference to FIG. 10.

At operation 1002, the user device sends an update request for a current navigation route being used by a navigation application executing on the user device.

At operation 1004, the user device provides a description of the current navigation route to the server. In an approach, the description of the current route may comprise a set of support points and corresponding segment identifiers for the current navigation route. The set of support points includes a start point and a destination point for the route.

In an approach, the set of support points and corresponding segment identifiers may be used to reconstruct the current navigation route being used by the user device at the server. Moreover, this information may be used to generate one or more updated navigation routes in accordance with one or more conditions.

In one embodiment, in order to conserve resources and minimize a size of the data set for transmitting information to reconstruct the current navigation route, each point in the set of support points may be selected to be encoded because it occurs at an intersection of segments where an angle of intersection is greater than a threshold angle (e.g., 1 degree, 5 degrees, 10 degrees, 15 degrees, etc.). The threshold angle may be set by the user device, navigation application, and/or the server in order to maintain a desired size of data set for use in transmitting information about the current navigation route to another device without utilizing excessive bandwidth, but still allowing the other device to determine the current navigation route from the reduced subset of points (the support points, which include the start and destination points).

A route-codec library may be used by the user device to encode a navigation route as route data. The user device may store a consecutive list of “support points” corresponding to segments on its map. Each support point may be encoded to include coordinates, a bearing of the underlying segment at that exact location (e.g., in degrees from North), a road class description, a distance from the route's start point, and a unique identifier for the segment. This segment identifier is unique in the sense that no other segment on the same map, but also any other previous map version, has the same segment identifier. The segment identifier also encodes a direction of movement along the segment.

In one embodiment, the user device is configured to generate a set of “support points” (and corresponding segments) to describe a currently-used route. Because the exact currently-used route does not need to be drawn and reproduced by the server on its map based on the support points and corresponding segments alone, a smaller set of points may be selected by the user device for the support points, which are still able to convey the major inflection points along the currently-used route. The server can recreate the currently-used route using its own map based on the set of support points (and in some cases further analysis), while significantly reducing bandwidth needed for transmission of the description of the currently-used route.

In one embodiment, starting from the origin, the user device iterates over the segments of the currently-used route in order. At each segment i, user device checks whether the transcoder module on the server would find segment i from the previous segment i−1 using the server's map data. If that is the case, no routing point is needed for segment i; otherwise, a routing point is added with the data from segment i.

Whether the transcoder module on the server would find segment i from segment i−1 is determined by checking the reachable segments at the junction separating the two segments. One consideration is whether segment i is the only segment that has a deviation from straight of less than a preconfigured angle (e.g., 1 degree, 5 degrees, 10 degrees, 15 degrees, etc.). In this case, a support point is not added. Another consideration is whether a support point has been placed for a predetermined distance (e.g., 50 km, 100 km, 200 km, 500 km, etc.). If no support point has been added for more than the predetermined distance, the user device adds a support point. The addition of intermediate routing points based on more than the predetermined distance existing between routing points may be selectively enforced (such as with a setting on the user device) or based on whether a fixed upper bound on a maximum distance between support points is specified on either transcoder module.

This route generation and encoding approach usually results in a small number of support points (lower tens) and basically mimics a co-driver which gives instructions to a driver only in the case where continuing to drive straight ahead would cause a deviation from the determined route.

Decoding the encoded route on the server may be performed by analyzing the ordered series of support points and associated segments. Should the segments not align with information in the server's map, shortest-route queries between each consecutive support point pair in the encoded route may be performed to reconstruct the currently-used route provided by the user device. The server does not need to be able to draw the route using the support points (and corresponding segments) alone; instead, the server may perform additional processing to determine intermediary steps, segment, and/or points which are not included in the description of the currently-used route (relying on support points). However, the set of support points are selected by the user device to minimize the further analysis performed by the server to reconstruct the currently-used route.

For any route, the set of support points are a subset of the set of routing points determined by the server. Therefore, in one embodiment, when the server provides a route initially in response to a route request from a user device, the server may determine candidate support points from amongst the routing points encoded into the route data. Once the candidate support points are determined, it is simple for the server to indicate which of the routing points should be returned as support points should the user device request updates to the route. The indications of candidate support points may be made using a flag or bit associated with a corresponding routing point, in several approaches.

In one embodiment, when the server indicates candidate support points from amongst the provided routing points, the user device may simply determine which of the candidate support points along the route have not yet been traversed, and return those support points to the server to describe the currently-used route when requesting a route update.

At operation 1006, the user device receives route data comprising one or more ordered series of routing points. Each ordered series of routing points describe a route from the start point to the destination point that satisfies one or more conditions. Moreover, the routing points correspond, respectively, to segments on a map. In addition, the one or more ordered series of routing points describe a route from the start point to the destination point according to the one or more conditions.

At operation 1008, the user device analyzes the route data against a map of the user device to construct one or more updated navigation routes, as described in various embodiments herein.

At operation 1010, the user device displays at least one of the one or more navigation routes. In a further approach, all received navigation routes may be displayed in an interface that allows a user to select which of the navigation routes to utilize for traversing to the destination point.

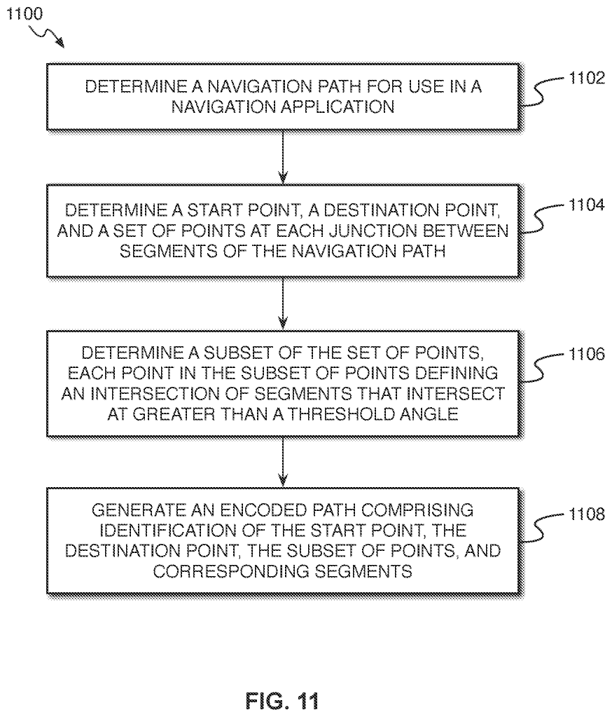

FIG. 11 is a flow diagram of an example method 1100 for encoding a route for transmission, e.g., for use in requesting updates from a server. For example, method 1100 may be performed, with reference to FIG. 1, by user device 102 to request updated information from server 118, as described above. In another example, method 1100 may be performed by server 118 to provide updated information to a user device 102 for use in the navigation application to provide a navigation route, as described above. Method 1100 will now be described with continued reference to FIG. 11.

At operation 1102, a device determines (e.g., obtains, reads from memory, etc.) a navigation route for use in a navigation application. The navigation route may be a route that is currently being used by user device to provide navigational instructions to a user of the user device in one approach. The navigation route may be newly generated or updated by the server for updating a route (or providing a new route) to the user device in another approach.

At operation 1104, the device determines a start point, a destination point, and a set of points at each junction between segments of the navigation route. In a further embodiment, the device determines all segments which combine to define the navigation route, each segment being a line between two points that are identifiable on a map by a corresponding segment identifier. The device may further determine attributes for the points, such as a corresponding coordinate, traversal direction, inflection angle, etc. These attributes may be stored as metadata with the set of points and the start and destination points, in an approach.

At operation 1106, the device determines a subset of the set of points in order to minimize a size of the data set that defines the navigation route. Each point in the subset of points at an intersection of segments where an angle of intersection is greater than a threshold angle (e.g., 1 degree, 5 degrees, 10 degrees, 15 degrees, etc.). The threshold angle is set by the device in order to obtain a desired size of data set for use in transmitting information about the navigation route to another device without utilizing excessive bandwidth, but still allowing the other device to determine the navigation route from the reduced subset of points, along with the start and destination points.

When a server is performing method 1100 to send details for a navigation route to a user device, the server may modify operation 1106 to send a more complete set of routing points to the user device. This more complete set (which includes more routing points than support points generated by a user device, but not all of the set of points in any given route) allows the user device to reconstruct the navigation route in the navigation application without performing all of the processing that takes place on the server. In this way, the server may offload some of the processing burden from the user device, minimize transmission size, provide a visually complete and accurate representation of the navigation route for a map of the user device, and ensure 100% decoding success of the navigation route on the user device.

At operation 1108, an encoded route is generated based on the subset of points and the start and destination points. The encoded route comprises identification of the subset of points, the start point, the destination point, and in some approaches, corresponding segments therebetween. The segments may be identified using segment identifiers that are able to be used on multiple versions of a map and may be used to uniquely identify the various segments regardless of the version of map being used to decode the encoded route.

After the encoded route is generated, it may be sent to any device that is configured to decode the encoded route, such as a user device executing a navigation application, a server, etc.

Quality Metrics

The quality of a route-codec library for encoding and decoding a navigation route may be quantified by determining a size of a particular encoded route as well as a decoding error rate associated with using the particular encoded route. The more data is kept in the encoded route (a larger encoded route) should result in fewer decoding errors when decoding the encoded route. However, this scheme requires the cost of increased size in transmission bandwidth and storage space.

Conversely, encoding a route with as little information as possible while still allowing for decoding of the route probably will result in a high decoding error rate, but such a scheme saves on transmission bandwidth and storage space. In addition to these metrics, the runtime, processor power, and processor usage needed for encoding and decoding (en-/de-coding performance) is another important measurable.

The route-codec library described herein in various embodiments provides for a negligible decoding error rate, reduced transmission data set size, and reduced processing on the user device. These advantages, in one embodiment, are enabled by the use of segment identifiers to identify the various segments that traverse an encoded navigation route instead of relying on more extensive attributes to describe the points and connections of a route.

### Graphical User Interfaces

This disclosure above describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radio buttons, checkboxes and any other mechanism for receiving input from, or providing feedback to a user.

### Privacy

As described above, one aspect of the present technology is the gathering and use of data available from various sources to improve the output signal provided to a display device. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve and/or refine the output signal of a media device or mobile device provided to a display device for display thereon. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of services for refining the output signal of a media device, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, the output signal provided to the display device may be refined by inferring preferences based on non-personal information data or a bare minimum amount of personal information, such as the content being requested by the device associated with a user, other non-personal information available to the calibration services, or publicly available information.

### Example System Architecture

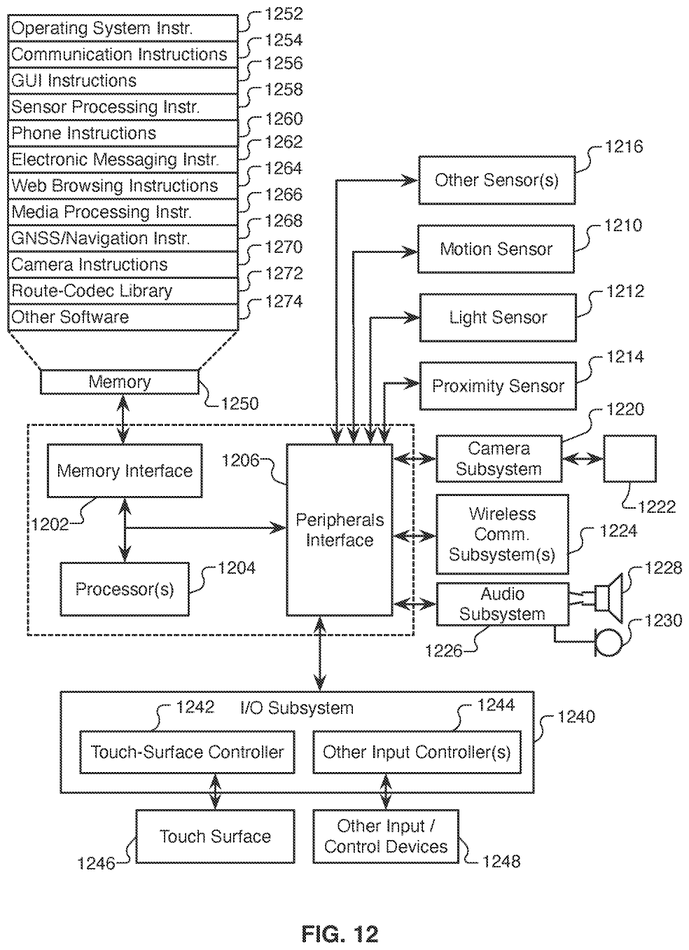

FIG. 12 is a block diagram of an example computing device 1200 to implement the features and processes of FIGS. 1-11. The computing device 1200 can include a memory interface 1202, one or more data processors, image processors and/or central processing units 1204, and a peripherals interface 1206. The memory interface 1202, the one or more processors 1204 and/or the peripherals interface 1206 can be separate components or can be integrated in one or more integrated circuits. The various components in the computing device 1200 can be coupled by one or more communication buses or signal lines.

Sensors, devices, and subsystems can be coupled to the peripherals interface 1206 to facilitate multiple functionalities. For example, a motion sensor 1210, a light sensor 1212, and a proximity sensor 1214 can be coupled to the peripherals interface 1206 to facilitate orientation, lighting, and proximity functions. Other sensors 1216 can also be connected to the peripherals interface 1206, such as a global navigation satellite system (GNSS) (e.g., GPS receiver), a temperature sensor, a biometric sensor, magnetometer or other sensing device, to facilitate related functionalities.

A camera subsystem 1220 and an optical sensor 1222, e.g., a charged coupled device (CCD) or a complementary metal-oxide semiconductor (CMOS) optical sensor, can be utilized to facilitate camera functions, such as recording photographs and video clips. The camera subsystem 1220 and the optical sensor 1222 can be used to collect images of a user to be used during authentication of a user, e.g., by performing facial recognition analysis.

Communication functions can be facilitated through one or more wireless communication subsystems 1224, which can include radio frequency receivers and transmitters and/or optical (e.g., infrared) receivers and transmitters. The specific design and implementation of the communication subsystem 1224 can depend on the communication network(s) over which the computing device 1200 is intended to operate. For example, the computing device 1200 can include communication subsystems 1224 designed to operate over a GSM network, a GPRS network, an EDGE network, a Wi-Fi or WiMax network, and a Bluetooth™ network. In particular, the wireless communication subsystems 1224 can include hosting protocols such that the device 120 can be configured as a base station for other wireless devices.

An audio subsystem 1226 can be coupled to a speaker 1228 and a microphone 1230 to facilitate voice-enabled functions, such as speaker recognition, voice replication, digital recording, and telephony functions. The audio subsystem 1226 can be configured to facilitate processing voice commands, voice printing and voice authentication, for example.

The I/O subsystem 1240 can include a touch-surface controller 1242 and/or other input controller(s) 1244. The touch-surface controller 1242 can be coupled to a touch surface 1246. The touch surface 1246 and touch-surface controller 1242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 1246.

The other input controller(s) 1244 can be coupled to other input/control devices 1248, such as one or more buttons, rocker switches, thumb-wheel, infrared port, USB port, and/or a pointer device such as a stylus. The one or more buttons (not shown) can include an up/down button for volume control of the speaker 1228 and/or the microphone 1230.

In one implementation, a pressing of the button for a first duration can disengage a lock of the touch surface 1246; and a pressing of the button for a second duration that is longer than the first duration can turn power to the computing device 1200 on or off. Pressing the button for a third duration can activate a voice control, or voice command, module that enables the user to speak commands into the microphone 1230 to cause the device to execute the spoken command. The user can customize a functionality of one or more of the buttons. The touch surface 1246 can, for example, also be used to implement virtual or soft buttons and/or a keyboard.

In some implementations, the computing device 1200 can present recorded audio and/or video files, such as MP3, AAC, and MPEG files. In some implementations, the computing device 1200 can include the functionality of an MP3 player, such as an iPod™.

The memory interface 1202 can be coupled to memory 1250. The memory 1250 can include high-speed random-access memory and/or non-volatile memory, such as one or more magnetic disk storage devices, one or more optical storage devices, and/or flash memory (e.g., NAND, NOR). The memory 1250 can store an operating system 1252, such as Darwin, RTXC, LINUX, UNIX, OS X, WINDOWS, or an embedded operating system such as VxWorks.

The operating system 1252 can include instructions for handling basic system services and for performing hardware dependent tasks. In some implementations, the operating system 1252 can be a kernel (e.g., UNIX kernel). In some implementations, the operating system 1252 can include instructions for performing voice authentication. For example, operating system 1252 can implement the third-party navigation GUI generation features as described with reference to FIGS. 1-11.

The memory 1250 can also store communication instructions 1254 to facilitate communicating with one or more additional devices, one or more computers and/or one or more servers. The memory 1250 can include graphical user interface instructions 1256 to facilitate graphic user interface processing; sensor processing instructions 1258 to facilitate sensor-related processing and functions; phone instructions 1260 to facilitate phone-related processes and functions; electronic messaging instructions 1262 to facilitate electronic-messaging related processes and functions; web browsing instructions 1264 to facilitate web browsing-related processes and functions; media processing instructions 1266 to facilitate media processing-related processes and functions; GNSS/Navigation instructions 1268 to facilitate GNSS and navigation-related processes and instructions; and/or camera instructions 1270 to facilitate camera-related processes and functions.

The memory 1250 can store other software instructions 1272 to facilitate other processes and functions, such as the route-codec library functionality as described with reference to FIGS. 1-11.

The memory 1250 can also store other software instructions 1274, such as web video instructions to facilitate web video-related processes and functions; and/or web shopping instructions to facilitate web shopping-related processes and functions. In some implementations, the media processing instructions 1266 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 1250 can include additional instructions or fewer instructions. Furthermore, various functions of the computing device 1200 can be implemented in hardware and/or in software, including in one or more signal processing and/or application specific integrated circuits.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. A method comprising:
sending, by a user device, a request for a navigation route for use in a navigation application executing on the user device;
providing, by the user device, a start point and a destination point for generating the navigation route;
receiving, by the user device, route data comprising one or more ordered series of routing points, each ordered series of routing points describing a route from the start point to the destination point that satisfies one or more conditions;
analyzing, by the user device, the route data against a map of the user device to construct the navigation route; and
displaying, by the user device, the navigation route.

2. The method as recited in claim 1, wherein the map of the user device is different from a map used to encode the one or more ordered series of routing points, and wherein the user device decodes the one or more ordered series of routing points using a codec library that is used to encode the one or more ordered series of routing points.

3. The method as recited in claim 1, further comprising providing, by the user device, a series of segment identifiers that describe a current navigation route being used by the navigation application.

4. The method as recited in claim 3, further comprising providing, by the user device, an ordered series of support points along the current navigation route, each support point being located at an intersection between adjacent segments of the current navigation route.

5. The method as recited in claim 4, further comprising:
determining, by the user device, each intersection of segments along the current navigation route at which an angle of intersection between adjacent segment pairs is greater than a threshold angle of deviation, the angle of intersection being determined as a smallest absolute angle of deviation from a current path direction; and
selecting, by the user device, points corresponding to each adjacent segment pair where the angle of intersection is greater than the threshold angle of deviation to form the ordered series of support points.

6. The method as recited in claim 1, wherein analyzing the route data comprises:
identifying, by the user device, one or more segments that correspond to the one or more ordered series of routing points;
determining, by the user device, segment identifiers corresponding to the one or more segments using the map of the user device; and
responsive to a particular segment identifier not being described in map data of the map of the user device: performing map-matching for routing points associated with the particular segment identifier based on coordinates and attributes for each routing point associated with the segment identifier.

7. The method as recited in claim 6, wherein analyzing the route data further comprises:
retrieving, by the user device, segments in between any of the one or more ordered series of routing points that remain unmatched to a segment; and
performing a search algorithm between each adjacent unmatched routing point pair using a threshold angle of deviation to discard outgoing segments which exceed the threshold angle,
wherein the threshold angle of deviation corresponds to a threshold angle used to encode the route data.

8. A system comprising:
one or more processors; and
a non-transitory computer readable medium including one or more sequences of instructions that, when executed by the one or more processors, cause the one or more processors to perform a method comprising.
sending, by a user device, a request for a navigation route for use in a navigation application executing on the user device;
providing, by the user device, a start point and a destination point for generating the navigation route;
receiving, by the user device, route data comprising one or more ordered series of routing points, each ordered series of routing points describing a route from the start point to the destination point that satisfies one or more conditions;
analyzing, by the user device, the route data against a map of the user device to construct the navigation route; and
displaying, by the user device, the navigation route.

9. The system as recited in claim 8, wherein the map of the user device is different from a map used to encode the one or more ordered series of routing points, and wherein the user device decodes the one or more ordered series of routing points using a codec library that is used to encode the one or more ordered series of routing points.

10. The system as recited in claim 8, wherein the method further comprises providing, by the user device, a series of segment identifiers that describe a current navigation route being used by the navigation application.

11. The system as recited in claim 10, wherein the method further comprises providing, by the user device, an ordered series of support points along the current navigation route, each support point being located at an intersection between adjacent segments of the current navigation route.

12. The system as recited in claim 11, wherein the method further comprises:
determining, by the user device, each intersection of segments along the current navigation route at which an angle of intersection between adjacent segment pairs is greater than a threshold angle of deviation, the angle of intersection being determined as a smallest absolute angle of deviation from a current path direction; and
selecting, by the user device, points corresponding to each adjacent segment pair where the angle of intersection is greater than the threshold angle of deviation to form the ordered series of support points.

13. The system as recited in claim 8, wherein analyzing the route data comprises:
identifying, by the user device, one or more segments that correspond to the one or more ordered series of routing points;
determining, by the user device, segment identifiers corresponding to the one or more segments using the map of the user device; and
responsive to a particular segment identifier not being described in map data of the map of the user device: performing map-matching for routing points associated with the particular segment identifier based on coordinates and attributes for each routing point associated with the segment identifier.

14. The system as recited in claim 13, wherein analyzing the route data further comprises:
retrieving, by the user device, segments in between any of the one or more ordered series of routing points that remain unmatched to a segment; and
performing a search algorithm between each adjacent unmatched routing point pair using a threshold angle of deviation to discard outgoing segments which exceed the threshold angle,
wherein the threshold angle of deviation corresponds to a threshold angle used to encode the route data.

15. A non-transitory computer readable medium including one or more sequences of instructions that, when executed by one or more processors, cause the one or more processors to perform a method comprising:
sending, by a user device, a request for a navigation route for use in a navigation application executing on the user device;
providing, by the user device, a start point and a destination point for generating the navigation route;
receiving, by the user device, route data comprising one or more ordered series of routing points, each ordered series of routing points describing a route from the start point to the destination point that satisfies one or more conditions;
analyzing, by the user device, the route data against a map of the user device to construct the navigation route; and
displaying, by the user device, the navigation route.

16. The non-transitory computer readable medium as recited in claim 15, wherein the map of the user device is different from a map used to encode the one or more ordered series of routing points, and wherein the user device decodes the one or more ordered series of routing points using a codec library that is used to encode the one or more ordered series of routing points.

17. The non-transitory computer readable medium as recited in claim 15, wherein the method further comprises:
providing, by the user device, a series of segment identifiers that describe a current navigation route being used by the navigation application; and
providing, by the user device, an ordered series of support points along the current navigation route, each support point being located at an intersection between adjacent segments of the current navigation route.

18. The non-transitory computer readable medium as recited in claim 17, wherein the method further comprises:
determining, by the user device, each intersection of segments along the current navigation route at which an angle of intersection between adjacent segment pairs is greater than a threshold angle of deviation, the angle of intersection being determined as a smallest absolute angle of deviation from a current path direction; and
selecting, by the user device, points corresponding to each adjacent segment pair where the angle of intersection is greater than the threshold angle of deviation to form the ordered series of support points.

19. The non-transitory computer readable medium as recited in claim 15, wherein analyzing the route data comprises:
identifying, by the user device, one or more segments that correspond to the one or more ordered series of routing points;
determining, by the user device, segment identifiers corresponding to the one or more segments using the map of the user device; and
responsive to a particular segment identifier not being described in map data of the map of the user device: performing map-matching for routing points associated with the particular segment identifier based on coordinates and attributes for each routing point associated with the segment identifier.

20. The non-transitory computer readable medium as recited in claim 19, wherein analyzing the route data further comprises:
retrieving, by the user device, segments in between any of the one or more ordered series of routing points that remain unmatched to a segment; and
performing a search algorithm between each adjacent unmatched routing point pair using a threshold angle of deviation to discard outgoing segments which exceed the threshold angle,
wherein the threshold angle of deviation corresponds to a threshold angle used to encode the route data.
